(19) United States
(12) Patent Application Publication
(10) Pub. No.: US 2017/0109104 A1
(43) Pub. Date: Apr. 20, 2017

(54) MULTIPLE PLATFORM PRINTER CONFIGURATION

(71) Applicant: SATO HOLDINGS KABUSHIKI KAISHA, Tokyo (JP)

(72) Inventors: Martin DAHLBERG, Göteborg (SE); Lars-Åke BERG, Göteborg (SE); Magnus WIBECK, Göteborg (SE); Per ANDERSSON, Göteborg (SE); Mats HEDBERG, Tokyo (JP)

(73) Assignee: SATO HOLDINGS KABUSHIKI KAISHA, Tokyo (JP)

(21) Appl. No.: 15/129,225

(22) PCT Filed: Mar. 28, 2014
(86) PCT No.: PCT/EP2014/056316

§ 371 Date: Sep. 26, 2016

(51) Int. Cl. G06F 3/12; G06F 9/445; G06K 15/02

(52) U.S. Cl. CPC G06F 3/1209; G06F 3/123; G06F 3/1244; G06K 15/024; G06K 15/1802; G06F 3/1251; G06F 8/61; G06F 8/665

(57) ABSTRACT

The present invention relates to a printer being capable of parsing, understanding and evaluating multiple target package files that include printing resources not only for a single printer or for a single type of printer, but for multiple printers or multiple types of printers. For this purpose, the package file is augmented with platform information that is separately associated with each printer resource included in the package file. Thereby, the parser of the printer can discriminate whether or not a particular resource is applicable to itself. Consequently, only the resources such as firmware are installed that are valid and applicable to the printer. In the same manner, the resources can also be augmented with individual printer information, so as to indicate different resources to be installed on different printers, even if they are of the same type.

### FIELD OF THE INVENTION

The present invention generally relates to printers. More specifically, the present invention relates to the provision of printer configuration data in an environment having multiple types of printers.

### BACKGROUND ART

Many printing devices, such as label and tag printers including various kinds of thermal printers, require physical connections to computers for providing various kinds of printing-related functionality. In many instances, a computer must be physically connected to a printer for providing data for the printer. The physical connection may be either hard-wired or wireless, such as by means of WLAN (Wireless Local Area Network).

Some printers, including label and tag printers, operate as stand-alone units (stand-alone printers), without requiring a computer to be physically attached for operation. In these cases, a printer may be configured with memory, an input device such as a keyboard and an output device such as a display screen, for information to be provided to and from operators.

In any case, a printer must be configured with a plurality of different data such as firmware, fonts, communication software/firmware (for instance, WLAN or LAN) and other data defining the printer setup.

Typically, a label and tag printer is configured with one or more custom software program applications that provide selectable menu options shown on the display screen, and that receive user input from the operator. Customized data output may also be managed as a function of software applications. In particular, printers which have a Lua interpreter have emerged, and software applications may be provided in the form of Lua scripts.

In case of a permanent physical connection of the printer to a computer, firmware, Lua scripts and other data necessary for configuring the printer for performing printing operations can be provided over said connection. Eventually, however, even printing devices that operate as stand-alone units need to physically interface with a computer, for example, for maintenance or for upgrades of firmware, application software or other configuration data. For this purpose, either a temporary connection is established, or data are provided by means of a portable storage device such as a USB memory stick or an SD card.

In any case, the printer must be provided with the necessary data for configuring printing operations, which are stored and installed on the printer. Alternatively, printer firmware and other configuration data can be stored and installed on a (remote) computer, which is employed for forwarding printing instructions to the printer for performing a printing operation. Such a case is detailed in International Patent Application Publication WO 2012/086105 A1. Another situation, wherein printer firmware and other printer configuration data are installed on a computer, occurs if it is desired to emulate the printer functionality on the computer. This is done, for instance, to enable preview functionality without involving the printer itself. Such a case is detailed in International Patent Application Publication WO 2011/099064 A1.

Firmware and other configuration data are generally different for different types of printers (printing platforms). Conventionally, therefore, any firmware updates, fonts, scripts such as Lua scripts, layout formats and other configuration data are preferably developed for each type of printer and respectively deployed (i.e. stored and installed) on the respective printers, although there may be a partial coincidence, so that, for instance, certain fonts may be equally used by a few printer types, while other printer types require different fonts. The separate provision of resources to printers of different types is a drawback of conventional printing systems, in particular, in the case of printing systems having a mixed printer population.

### SUMMARY OF THE INVENTION

The present invention aims to provide a system and method for improving the provision of printing configuration data (resources), in particular, simplifying the data deployment in the case of a multiple printing platform environment, in particular, a respective data structure, a data processing device for generating the data structure and a computer/printer for evaluating and employing the data structure.

This is achieved by the features of the independent claims.

According to a first aspect of the present invention, a package file including a plurality of resources for a plurality of different printers and platform information indicating a type of printer is provided. The resources include data necessary for performing printing operations on the different printers. Each of the resources in the package file is associated with platform information indicating printer types corresponding to the resource.

According to a second aspect of the present invention, a computer readable recording medium having recorded thereon a package file according to the first aspect of the present invention is provided.

According to a third aspect of the present invention, a data processing device comprising a package file generation means that is adapted to generate a package file according to the first aspect of the invention is provided.

According to a fourth aspect of the present invention, a data processing device for controlling or emulating a printing operation of a particular printer is provided. The data processing device comprises a receiving section for receiving a package file according to the first aspect of the present invention. The data processing device further includes a package parsing section for parsing each resource included in the package file and comparing the platform information associated with each resource with the type of the particular printer. The package parsing section thereby determines those resources out of the plurality of resources included in the package file, the associated platform information of which indicates a printer type matching the type of the particular printer, as resources matching the type of the particular printer. The data processing device further includes an installing section for installing, on said data processing device, the resources determined by the package parsing section as matching the type of the particular printer.

A data processing device according to the fourth aspect of the present invention can be, in particular, the printer itself, or alternatively, a computer for remotely controlling a printer, or a computer emulating the printer, without being actually connected to the printer.

According to a fifth aspect of the present invention, a method of configuring a data processing device for controlling or emulating a printing operation of a particular printer is provided. The method comprises the step of receiving, at the data processing device, a package file according to the first aspect of the present invention. The method further comprises the step of parsing each resource included in the package file and comparing the platform information associated with each resource with the type of the particular printer. Thereby, those resources out of the plurality of resources included in the package file, the associated platform information of which indicates a printer type matching the type of the particular printer, are determined as resources matching the type of the particular printer. The method further comprises the step of installing, on the data processing device, the resources determined as matching the type of the particular printer.

It is the particular approach of the present invention to include the resources for different types of printers into a single multiple target platform package file, which is transmitted to each of the different types of printers or computers for remotely controlling or emulating the printers. The printers or computers for remotely controlling or emulating the printers are adapted to parse the multiple target platform package file and select only those resources that are compatible with the respective printer type, for being installed. For this purpose, the multiple target platform package file includes, in association with each resource, information about compatible printer types.

Preferably, the platform information associated with a resource is stored as an attribute of the resource, in the package file.

According to a preferred embodiment, at least a part of said resources in the package file is further associated with individual printer information indicating at least one individual printer out of printers of the types of printers indicated by the platform information associated with the resource. Thereby, resources can be deployed in a manner targeting individual printers, but nevertheless only a single package file is required. The individual printer information may also be stored as an attribute of the resource.

The individual printer information may include any kind of information suitable for unambiguously designating individual printers such as, but not limited to an IP-address, a MAC address (hardware address), an identifier in a telecommunications network, or an identifier such as a number used within a private network configuration for identifying individual printers.

Also, according to a preferred embodiment, each of the resources is further associated in the package file with type information indicating a type of the resource, such as but not limited to firmware, font, file WLAN firmware, Lua script, layout or setup configuration file. Also, the type information can be stored as an attribute of the resource. For instance, the package file can store the resources in tabular form, where each line corresponds to a resource and the columns correspond to a name designating the resource, the type of resource and an identifier of the platform or platforms compatible with the resource. This enables a simple parsing and evaluation of the multiple target package file.

Also, preferably, package files further include a header that contains a signature for identifying the package file and a version number of the package file. Upon evaluating such a header, a parser can parse the data correctly, since different versions may place data in a different order or add new information required to parse the rest of the package.

Resources included in the package file are, in particular, firmware, fonts, Lua scripts, sub-board firmware for LAN (Local Area Network) or WLAN (Wireless Local Area Network) and layout data, without being limited to those that have been given by way of example only. Generally, resources are data necessary for configuring the printer and performing printing operations, different from the actual print data such as text or image data to be printed. In particular, the resources may include a setup configuration file, which will be detailed below.

Preferably, the package file generation means in a data processing device according to the third aspect of the present invention includes a setup configuration tool for creating, as one of the resources, a setup configuration file that is included into a package file.

More preferably, the setup configuration tool is capable of creating, for a particular type of printer, both a full setup configuration file and a partial setup configuration file. While the full setup configuration file includes every setting in the printer, the partial configuration file includes only a part of the settings in the printer, which are desired to be changed in a specific situation. Thereby, the computer having the package file generation means, which is usually provided on the premises of some distributor of configuration resources, such a Value Adding Reseller (VAR, i.e. an institution not only distributes resources but also provides extensions and additions, such as additional Lua scripts), is capable of providing resources in an easy manner to multiple customers having different printing platform types, and, moreover, it is not necessary for a particular type of printer at the premises of the recipient to be provided with and know all possible settings of the printer, in order to only change a few of them. Also, an operator who prepares setup configuration files does not even have to know all settings of a printer, if it is desired to only change a few of them, if the operator uses the tool of partial configuration files.

Still more preferably, the setup configuration tool includes a graphical user interface, wherein an operator at the premises of the distributor of the setup configuration file elects the settings to be included in a partial configuration file, out of all settings of the printer. For instance, the graphical user interface can list all settings of the printer in the form of a tree-like hierarchical structure that is easy to grasp.

Preferably, when at least a part of said resources in the package file being further associated with individual printer information indicating at least one individual printer out of printers of the types of printers indicated by the platform information associated with the resource, said package parsing section in the recipient's printer/computer further compares the individual printer information with individual printer information of the particular printer, thereby determining those resources out of the resources associated with individual printer information, which have associated therewith an individual printer information matching the individual printer information of the particular printer, and said installing section installing on said data processing device, out of the resources associated with individual printer information and matching the type of the particular printer, only the resources, which have associated therewith an individual printer information matching the individual printer information of the particular printer. Thereby, an individually targeted deployment of resources is enabled.

Also preferably, the recipient's printer/computer includes a setup configuration section for parsing a setup configuration file included in the resources targeted for the particular printer type. The printer settings of the particular printer are performed in accordance with the settings included in the setup configuration file. More preferably, said setup configuration section is capable of parsing and understanding also a partial setup configuration file. Therefore, still more preferably, the partial setup configuration file has the same syntax as the full setup configuration file that includes every setting of the particular printer, where those entries in the partial configuration file that do not include valid data are left empty (or filled with dummy data).

Preferably, when the setup configuration section parses a partial configuration file, it changes only the desired settings which are included in the partial configuration file and leaves the settings that are not included in the partial configuration file unchanged. This simplifies and speeds up the update procedure, and moreover by this it minimizes the probability of errors, since the amount of data to be generated and distributed by the distributor as well as to be manipulated on the recipient's side is reduced.

Also preferably, the installed partial configuration file is deleted after it has been parsed and used for changing the desired settings. While a particular printer (or controlling/emulating computer) always retains a copy of the full configuration file (for instance, for recovery and backup purposes), any partial configuration files, basically including updates, are not retained at the printing platform, thereby reducing storage requirements.

According to preferred embodiments, a full setup configuration file is, in particular, transmitted and parsed at the start up of the printer. Also, a full setup configuration file can be parsed and used for completely changing the configuration by newly setting every setting of the printer.

The computer for remotely controlling or emulating a particular printer, besides a standard personal computer or laptop computer, can also be a mobile device such as a tablet computer or a smartphone. The present invention is applicable to different kinds of printers, in particular, both stand-alone printers and online printers. Also preferably, the particular printer employing the present invention is a label and tag printer. For instance, the data processing device according to the fourth aspect of the present invention can be realized in the form of a printer, in particular, a label and tag printer.

Further features and advantages of the present invention are set forth in dependent claims.

### BRIEF DESCRIPTION OF THE DRAWINGS

Additional features and advantages of the present invention will become apparent in the following and more particular description as illustrated in the accompanying drawings, wherein:

FIG. 1 illustrates an exemplary hardware arrangement of a printing environment in accordance with an embodiment employing the present invention;

FIG. 2 illustrates the functional elements of an example information processor or user workstation shown in FIG. 1;

FIG. 3 gives an overview of the system configuration for distributing multiple platform printer resource package files, in accordance with an embodiment of the present invention;

FIG. 4 illustrates an exemplary configuration of a multiple platform printer resource package file in accordance with an embodiment of the present invention;

FIG. 5 illustrates an example of a multiple target package file storing the resources in association with platform information and type information in tabular form;

FIG. 6 is a flow chart illustrating a method of parsing and installing resources from a multiplatform printer resource package file that is performed on a target printer or computer, in accordance with an embodiment of the present invention;

FIG. 7 illustrates a graphical user interface of a setup configuration tool of a data processing device on the premises of a vendor/distributor of printer resources;

FIG. 8 illustrates a particular example of a customer configuration employing the present invention in a label and tag printer, according to an embodiment;

FIG. 9 illustrates to a concept of employing the present invention, in accordance with another embodiment;

FIG. 10 illustrates an exemplary embodiment of deploying an application, in accordance with the present invention;

FIG. 11 illustrates a bidirectional communication between a smart phone as a controlling computer and a label and tag printer, in accordance with a particular embodiment; and

FIG. 12 is a block diagram that illustrates software components that are provided with a computer emulating a printer.

### DETAILED DESCRIPTION

The present invention provides an advanced system for distributing printer resources from a center such as a vendor or a reseller to a recipient such as a customer, which is particularly suitable in the case of a mixed printer population environment, i.e. a printing system arrangement, wherein plural types of printers are present at the same time, and a respective data structure in the form of a package file that is called multi-platform printer resource package file or simply multiple target package file which includes a plurality of resources for a plurality of different printers. By means of the present invention, for customers with a mixed printer population, it is sufficient to distribute only a single file to all printers to get them to install the most up to date resources, in particular, the latest firmware. Also, layouts and fonts that are used by any one of the printers can be included into the same package. Since each of the resources in the multiple target package file is associated with platform information indicating the corresponding printer types, there is no risk that a printer will install wrong resources, in particular wrong firmware, which is not intended for said printer. The same is true for other resources such as layouts and fonts, which are also distributed by the multiple target package file that is used by all printers. Thus, according to the present invention, it is sufficient to generate a single file that can be used on all printers to obtain the most up to date layouts, fonts, and firmware etc. on all of them, even if there are two or more different types of printers (requiring different resources, in particular, different firmware versions).

In the following, a detailed description will be given with reference to the figures of the drawings, in which like reference numerals represent like elements.

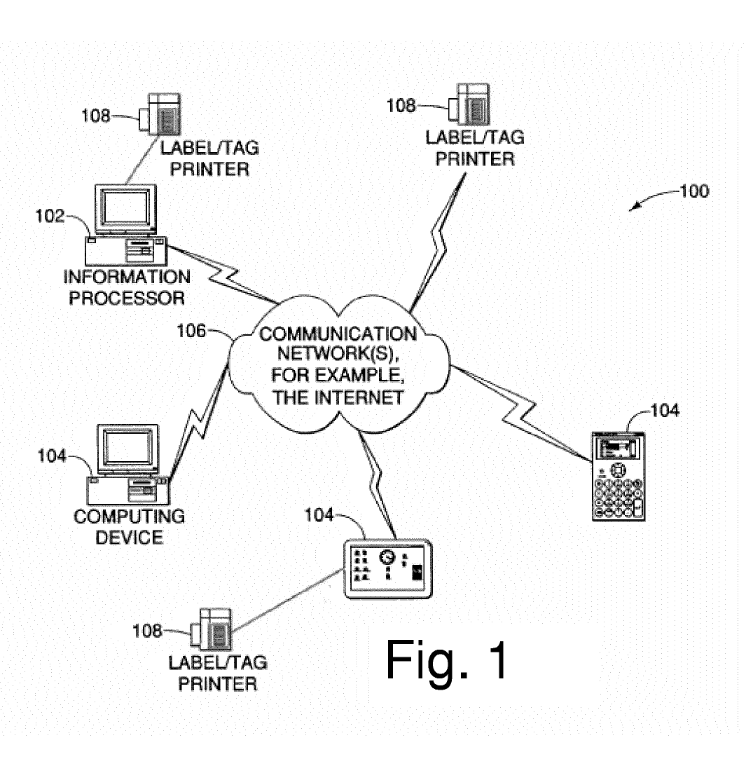

FIG. 1 illustrates an exemplary hardware arrangement of a printing environment, in the framework of which the present invention is employed, which is generally referred to as system 100.

System 100 preferably comprises at least one information processor 102, which may be configured to operate as an internet web server and database file server and is programmed and configured to access communication network 106 and communicate with computing devices (user workstations) 104. Computing devices 104 and information processors 102 may communicate via the known communication protocols such as transmission control protocol/internet protocol (TCP/IP). Via the communication network 106, remote server configurations such as those on the premises of vendors or distributors, printer firmware and other resources can get access (not shown) to system 100.

Information processor 102 may be provided with an integrated development programming environment (IDE) so as to develop applications. The person skilled in the art is aware of IDE development tools. Further details are not essential for the present invention and are therefore omitted herein. For instance, applications can be developed in a scripting language such as the Lua programming language. The Lua scripting language has been designed for portability and renders it possible to run the same applications on multiple platforms. Information processor 102 may also be provided with printer firmware and/or software applications that are installed in any one of printers 108, or which belong to other printers physically not connected to system 100.

Computing devices 104 are preferably mobile devices such as operating one or more of the Android, iPhone, or Windows mobile operating systems, smartphone devices, tablet computing devices or other mobile portable devices. Moreover, computing devices (user workstations) 104 can be personal computers, minicomputers, mainframe computers, laptop computers or personal digital assistants (PDA). In addition, information processor 102 and/or computing device 104 may operate one or more software applications provided on printing device 108 for remote configuration and/or operation. In this way, software applications can be executed and used to control printing device 108 remotely.

Communication network 106 may be a global public communication network such as the Internet, but can also be a wide area network (WAN), a local area network (LAN), a wireless local area network (WLAN), and an intranet or other network that enables computing devices and peripheral to communicate, and to have access to remote sites via a global network such as the Internet.

Printers 108 are preferably label and tag printers and operable to print labels and tags of data received from information processor 102 or computing device 104. A printer 108 may either be directly connected to a particular computing device or workstation, or may be a web printer that is accessed from a computing device 104 or information processor 102 via communication network 106. Printer 108 may be provided with keyboard and display to enable input and output functionality with the printer 108, in addition or in the absence of or in conjunction with information processor 102. Keyboard and display may be external devices not directly coupled to printer 108, or may form an integral part of the printer 108 themselves. Preferably, the display supports a wide selection of fonts and coding types, for example, for many different written languages.

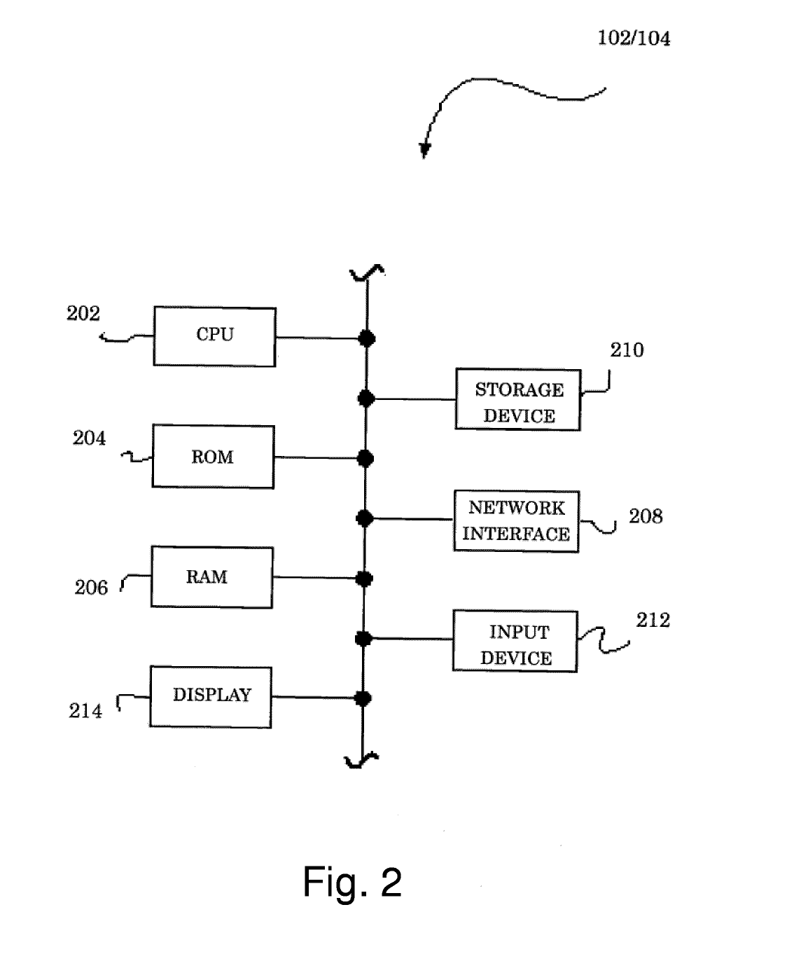

FIG. 2 illustrates one or more functional elements of an example information processor 102, and/or computing device 104, and includes one or more central processing units (CPU) 202 used to execute software code and control operations. Other elements shown in FIG. 2 include Read-Only Memory (ROM) 204, Random Access Memory (RAM) 206, one or more networking interfaces 208 to transmit and receive data to and from other computing devices across a communication network, storage devices 210 such as a hard disc drive, floppy disc drive, tape drive, CD-ROM, DVD, SD card or USB memory stick for storing program code databases and application data, one or more input devices 212 such as a keyboard, mouse, trackball, microphone and the like, and display 214. Further, one or more functional elements 202-214 may be suitably configured or provided with printer 108, as well.

The various components illustrated in FIG. 2 need not be physically contained within a single device chassis or even located in a single location. For example, storage device 210 may be located at a site that is remote from the remaining elements of information processor 102, and may even be connected to CPU 202 across communication network 106 via network interface 208. Information processor 102, computing device 104 and/or printing device 108 may include a memory equipped with sufficient storage, so as to provide or access the necessary databases, forums and other community services communicating hypertext mark-up language (HTML), driver, applets, or Active-X control programs. A CPU(s) 202, network interface(s) 208 and memory and storage devices are selected to ensure that capacities are arranged to accommodate expected demand.

The nature of the invention is such that one skilled in the art of writing computer executable code (i.e. software) can implement the functions described herein using one or more of a combination of popular computer programming languages, scripting languages and developing environments including but not limited to Lua, C, C++, Visual Basic, Java, HTML, XML, Active Server Pages, Java Server Pages, servlets, MYSQL and PHP.

Although the present invention is described by way of example herein and in terms of a web-based system using web browsers and a website server (e.g., information processor 102), system 100 is not limited to such a configuration. It is contemplated that system 100 is arranged in such a way that label and tag printer 108 communicates with and outputs data received from information processor 102 and/or computing device 104 using any known communication method, for example, using a non-internet browser Windows viewer coupled with a local area network protocol, such as the Internet Packet Exchange (IPX), dial-up, third-party, private network or a Value Added Network (VAN).

It is further contemplated that any suitable operating system can be used on information processor 102 and computing device 104, for example, various Windows operating systems, MAC OS, Unix, Linux, Palm OS, pocket PC, Blackberry, Android and others. In an embodiment, an application (e.g., a printer emulator such as a “Psim” application) is installed on a mobile computing device 104 that is running the Android operating system. The application configures mobile computing device 104 to operate as an external input/output device for the printing device. In this embodiment, computing device 104 may run one or more AEP applications, such as those developed in the AEP Works development PC application and control the printing device accordingly.

AEP stands for “Application Enabled Printing”. An AEP printer is configured with software, which may be firmware that configures an AEP printer to run custom printing-related software applications. In an embodiment, an interpreter or other software program is provided within an AEP printer that configures the AEP printer to execute one or more instructions, such as custom printing software application that is suitable for a particular business or type of data. The instructions may be remotely transmitted by the mobile computing device and received by the AEP printing device, and the interpreter configured with the AEP printing device executes instructions within AEP printing device. For instance, according to an embodiment, one or more printer-related software applications operate on a tablet-style computing device, such as a device operating the Android operating system, and utilize scripts and/or code libraries that facilitate applications to execute on or by a printing device, remotely. In short, an AEP printer is a standalone printer.

Mobile device 104 and printing device 108 are configured to communicate (e.g., via USB, Bluetooth, Wi-Fi, 3G or other suitable connectivity) and the transmission and reception of commands such as bitmap or SBPL commands enable the printing device to operate in accordance with one or more applications, such as AEP applications. In this embodiment, custom applications operate on mobile computing device 104 and control printing device 108, which prevents the need to modify hardware configurations of an existing printer and still supply substantial functionality by mobile computing device 104.

In an embodiment, a printer, in particular, an AEP printing device, is provided with a Lua language interpreter. Thereby, instructions written in Lua may be transmitted from the mobile computing device to the AEP printing device and executed by the interpreter configured therewith. Such an embodiment enables significant printer-related functionality via a Lua program provided by the mobile computing device 104 and executed by the Lua interpreter provided with the AEP printing device 108.

Thus, a mobile computing device 104 operating an application operable on an AEP printer, for example, extends functionality to the printing device 108. For example, mobile device-related functionality such as provided via the touch screen of a tablet computer, as well as networking-related functionality, such as provided via Universal Serial Bus (USB), WLAN, GSM (Global System for Mobile Communications), third generation (3G) or fourth generation (4G) mobile communications standards, is extended to a printing device.

Provision of the printing device 108 with a scripting language interpreter, in particular a Lua interpreter, enables to execute programs inside the printer, so as to avoid the need for a host computer for execution of programs.

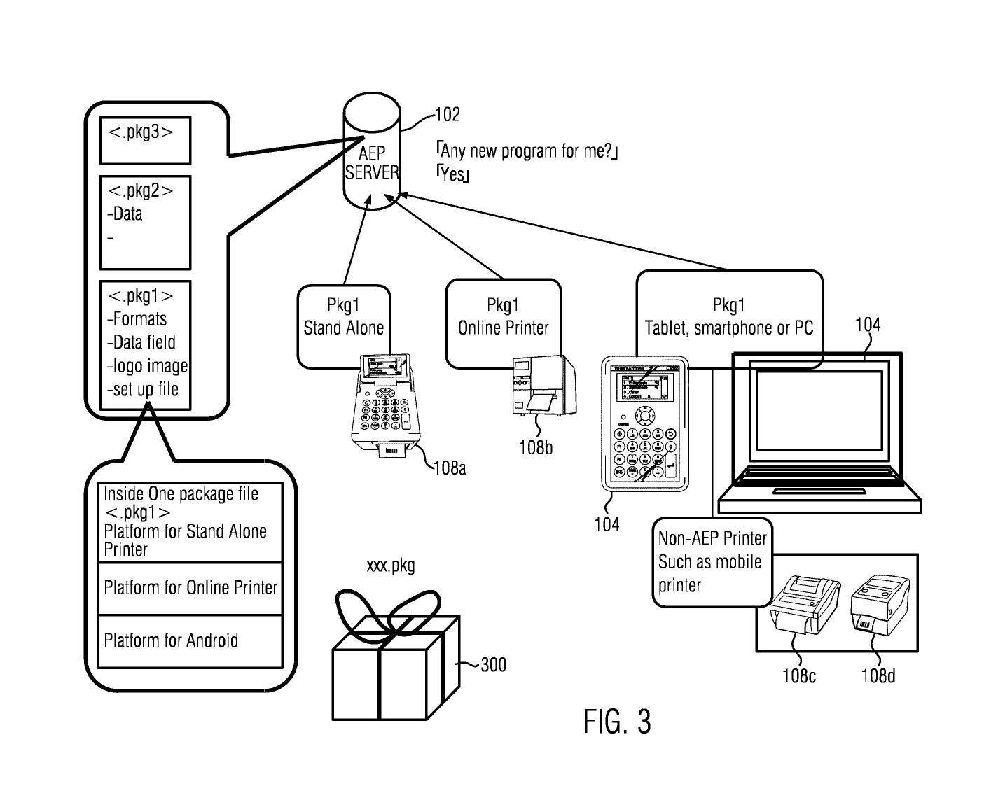

FIG. 3 illustrates a simplified example of a structure of a resource distribution system in accordance with the present invention. In a central position, AEP server 102 is illustrated, which has stored thereon a plurality of package files, including, in particular, those three package files shown on the left hand side of the drawing, labeled <.pkg 1>, <.pkg 2>, and <.pkg 3>. A symbolic illustration of a package file 300, which is generally designated by a fictitious file name having the extension pkg, such as xxx.pkg, is illustrated in the lower portion of FIG. 3. Moreover, FIG. 3 illustrates a plurality of printers 108, such as stand-alone printer 108a (preferably an AEP printer) and online printer 108b (possibly also an AEP printer but preferably not), as well as non-AEP printers 108c and 108d (preferably mobile printers). Further, plural computing devices 104, such as tablet computers, smartphones or personal computers are illustrated. Mobile printers 108c and 108d are controlled by any one of the computing devices 104 via a communication link as explained above with reference to FIGS. 1 and 2. Also, computing devices 104 may have printer firmware and a printer emulator for emulating the functionality of a printer not connected.

In view of the above, each of printers 108 and computing devices 104 requires printing resources to be installed thereon, and updated from time to time in view of progressing technical developments. For this purpose, in accordance with the illustrated embodiment, each of the devices 104 and 108 communicating with AEP server 102 poll the AEP server 102 to enquire whether any new resources are available. In accordance with the present invention, any available resources for each of the illustrated devices 104 and 108 that are peripheral to information processor (AEP server) 102 are included in a single package. In the illustrated case, this is PKG 1 (<.pkg 1>), which is illustrated in more detail in the bottom portion on the left hand side of FIG. 3. As can be seen therefrom, inside the single package file <.pkg 1>, there are resources for a platform for a stand-alone printer, resources for a platform for an online printer, as well as resources for a platform for Android that is capable of emulating or controlling a mobile printer. Of course, the exemplary contents of package file <.pkg 1> are not limited to those, but there may be other resources, for instance, for controlling a non-AEP mobile printer such as 108c or 108d through personal computer 104. As a consequence, upon a respective query, each of devices 108a, 108b and 104 connected to AEP server 102 is provided with the package, in the illustrated embodiment, upon request. A person skilled in the art is aware that the procedure for obtaining the package files is not limited to polling, to sending a request in general, but a new package file may also be provided from the server 102 to the peripheral devices such as 104 and 108 automatically, by broadcast or in a targeted manner.

More generally, a connection between the server and peripheral devices for distributing package files in accordance with the present invention is preferably established by means of a communication network such as but not limited to the Internet, a Local Area Network (LAN), a Wide Area Network (WAN), an intranet, or a telecommunications network including cellular phone networks. Also, a distribution is possible by a direct physical connection line such as but not limited to a USB connection cable or by means of portable storage devices such as but not limited to a USB memory stick, a memory card such as an SD card or an optical disk.

Each of the recipients, such as 108a, 108b and 104, is capable of distinguishing those resources that are designated for a particular recipient and accordingly selects and installs only the resources that are required for said particular recipient, as will be detailed below. In brief, each resource forming an entry in the package file, such as boot code, printer firmware, LAN firmware and WLAN firmware is tagged with a platform number. The printer uses the platform number to detect, whether the resource is intended for it or not. The platform information can indicate a specific platform (printer type) or a family of printers (including several types of similar printers). In addition, within the framework of the present invention, it is also possible to target individual printers, employing a more elaborate mechanism for identifying the targets for each entry, such as additionally providing, together with a printer type, also an individual identifier of a particular printer of said type or a plurality of particular printers of said type.

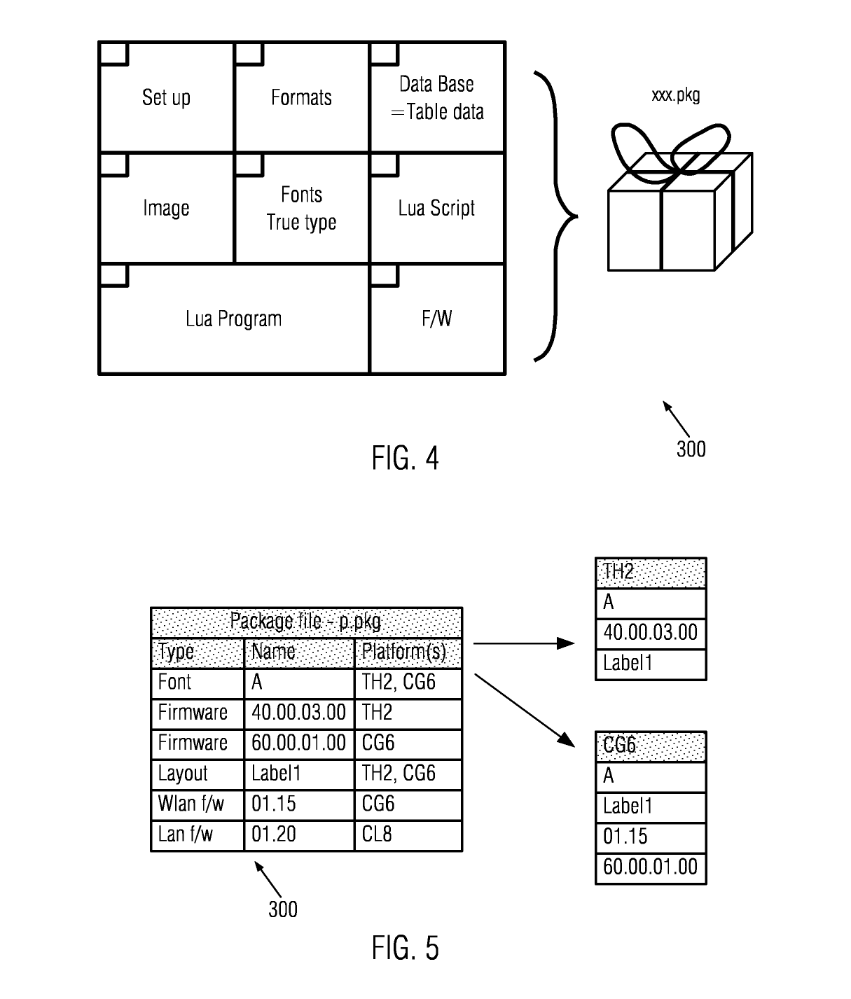

FIG. 4 provides for a more detailed illustration of the contents of an exemplary package file 300, symbolically again illustrated by means of a package with the fictitious name xxx.pkg on the right hand side of the drawing. Packages generally form a format that is enabled to simplify application and firmware distribution. The package is a collection of one or more of Boot code, main firmware (also called kernel), LAN firmware, WLAN firmware, scripts such as Lua code to be executed, as well as further resources including so-called “normal files”. “Normal files” in accordance with the present specification are, for example, true type fonts, formats (stored layouts), settings, databases, etc.

Boot code and main firmware entries will be used to upgrade the printer. Only the first successful boot and kernel will be done, if more than one is included. LAN and WLAN firmware update any corresponding LAN or WLAN option installed in the printer. The Lua code is executed as if a dofile ( ) had been called on a file with the Lua code contained in it. Files are copied to the file system of the printer. Directories in the path provided will be created if missing.

Some exemplary resources included in the package file 300 illustrated in FIG. 4 include firmware (F/W), Lua programs, Lua scripts, true type fonts, images, database data, preferably in tabular form as table data, formats and setup configuration files. Thus, generally speaking, a package file is a file than can contain a number of resources (i.e. other files), including but not limited to firmware, fonts, Lua scripts, sub-board firmware (WLAN, LAN, etc.) and setup configuration files.

Preferably, each resource in the package file 300 has an associated type (including but not limited to: firmware, font, file, WLAN firmware, etc.). Preferably, the type is not stored in the actual resource data but is an attribute of the resource, stored in the package file data.

According to the specific approach of the present invention, all of the resources included into the package file 300 are not limited to a single printer 108 (or target data processing device such as a user computer 104), but include resources to be used in a wide variety of printers. Each printer (or target computing device) takes the resources that are applicable for it.

For this purpose, each resource has associated target platform information indicating a target platform (or platforms), i.e. a printer type or printer types, which are stored in association with an entry defining the resource. A platform is the type of printer, and each platform type is compatible within itself. Different platforms may have completely different architectures (different CPUs, or different print widths), or may be simply incompatible in any other way.

In the following, the detailed description of the syntax of a package file in accordance with a specific exemplary embodiment will be described. As indicated, the following explanations are by way of example only, and the present invention is not limited to the particular syntax or notations given below for purposes of explanation and better understanding only.

A package file shall start with a package header, immediately followed by a list of entries (offset to and type of each entry in the file). The actual entries then follow.

The first portion, the main header shall start with a signature (“PKG”, or 0x504B4720) followed by its version, so it is possible to know which version it is. The version is four bytes, the first two are the major version and the second two are the minor version. Both fields are stored in big-endian order. The term “big-endian order” refers to a memory organization (byte order), wherein the byte having the most significant bits is stored first, i.e. at the lowest memory address. All multi-byte fields in the package file shall be stored in big-endian byte order.

Minor updates (1.0, 1.1, . . . ) keep compatibility (order, size, and placement of common fields). Major updates (2.0, 3.0, . . . ) break compatibility.

The package header

| | |
|---|---|
| { unsigned int magicSig; | // Signature, for identification |
| unsigned int version; | // Version of package file, fixed point |
| unsigned int items; | // Number of items in this package |
| unsigned int flags; | // Reserved for future use, should be all zero } |

is then immediately followed by items number of pkgItem structs:

| | |
|---|---|
| typedef struct | |
| { | |
| etype type; | // Type of entry - BOOT_ENT (boot binary), |
| | // KERN_ENT (kernel binary), FILE_ENT (file), or |
| | // LUAC_ENT (Lua code). |
| | // LAN_ENT and WLAN_ENT for lan/wlan binares. |
| | // Top 16 bits are reserved for flags |
| int offset; | // Offset of entry in this file |
| } pkgItem; | |

The lower 16 bits of etype is an enum:

typedef enum {

BOOT_ENT = 1, // Boot binary
KERN_ENT = 2, // Kernel binary
FILE_ENT = 3, // File to be copied
LUAC_ENT = 4, // Lua code to be executed
LAN_ENT = 5, // LAN binary
WLAN_ENT = 6, // WLAN binary

} etype;

An entry with an unknown etype is silently ignored.

“Offset” is counted from the beginning of the package file. If offset is zero, that entry is ignored. At the offsets pointed to by the pkgItem list entries with type BOOT_ENT/KERN_ENT LAN_ENT/WLAN_ENT a boot/kernel/LAN/WLAN binary is expected.

At the offset of a file entry (etype=FILE_ENT), a fileEntry struct shall be placed.

At the offset of a Lua code entry (etype_LUAC_ENT), a luaEntry struct shall be placed.

fileEntry: typedef struct

| | |
|---|---|
| { | |
| int data; | // Offset of file data from start of this header |
| unsigned int datalen; | // Length of file data |
| unsigned int crc; | // Adler32 of path, incl NUL and file data |
| int pathOffs; | // Offset of path from start of this header |
| unsigned int mode; | // Access mode (only rwx---rwx have effect) |
| unsigned int userOffs; | // Offset to account name (user) for file |
| | owner |

| | |
|---|---|
| unsigned int nPlatforms; | // Number of platforms this resource is for. |
| | // 0 (zero) indicates all available platforms. |
| unsigned int platforms[ ]; | // Array of platform identifiers for which this |
| | // resource is valid. nPlatforms long. |
| } fileEntry; | |

The path (at pathOffs+start of fileEntry header in file) shall be NUL terminated and may be either relative or absolute. Directory separator is ‘/’ (0x2F). The user name (at userOffs+start of fileEntry header in file) shall be NUL terminated. If the user does not exist in the printer, the owner of the file will be set to “user”.

luaEntry: typedef struct

| | |
|---|---|
| { | |
| int data; | // Offset of Lua code from start of this header |
| unsigned int datalen; | // Length of Lua code |
| unsigned int crc; | // Adler32 of data |

| | |
|---|---|
| unsigned int nPlatforms; | // Number of platforms this resource is for. |
| | // 0 (zero) indicates all available platforms. |
| unsigned int platforms[ ]; | // Array of platform identifiers for which this |
| | // resource is valid. nPlatforms long. |
| } luaEntry; | |

A particular advantage of having a single package file for multiple target platforms resides in the fact that the installing and distributing of a single file is easier for both the sender such as a VAR (value adding reseller) and recipient (customer). As indicated above, the file can be sent by any communication means, via email, hosted on a web server but also on a transferable medium such as an SD card, etc. The recipient devices themselves can decide which resources are meant for that specific device.

When the printer (or other platform, for instance the AEP for Android application on a smart phone) receives the package file and the command to install it, the package parser of the recipient will go through each resource contained in the package file. Only when the individual package installer finds a resource that matches its own platform and has a type that it understands, will it actually install the resource. An example of a package file 300 (p.pkg), where resources (designated by a name) are listed in tabular form in association with both platform information indicating for each resource one or plural printer types and type information indicating the type of the resource, is illustrated in FIG. 5.

In the illustrated exemplary case, multiple target package file p.pkg has five resources of the type's font, firmware (two entries), layout, WLAN firmware and LAN firmware. On the right hand side of the drawing, it is indicated in a symbolic manner that p.pkg with five resources shall be installed on two different platforms. Actually, only those resources marked with the matching platform are installed. In the present case, the two illustrated installing platforms, labelled TH2 and CG6 correspond to different firmware resource entries. On the other hand, font and layout resources are stored in common entries for both platforms, meaning that these resources are compatible with both platforms. WLAN firmware is only available for the CG6 resource, but not for TH2. Finally, LAN firmware is not available for any of the two platforms illustrated on the right hand side for installation, but only for a still different platform, labelled CL8.

As further illustrated on the right hand side of the figure, the TH2 platform will install only A, 40.00.03.00, and Label 1, since only those are marked for the TH2 platform. It ignores all other resources. On the other hand, the CG6 will install A, 60.00.01.00, Label 1 and 01.15, since only those match the CG6 platform.

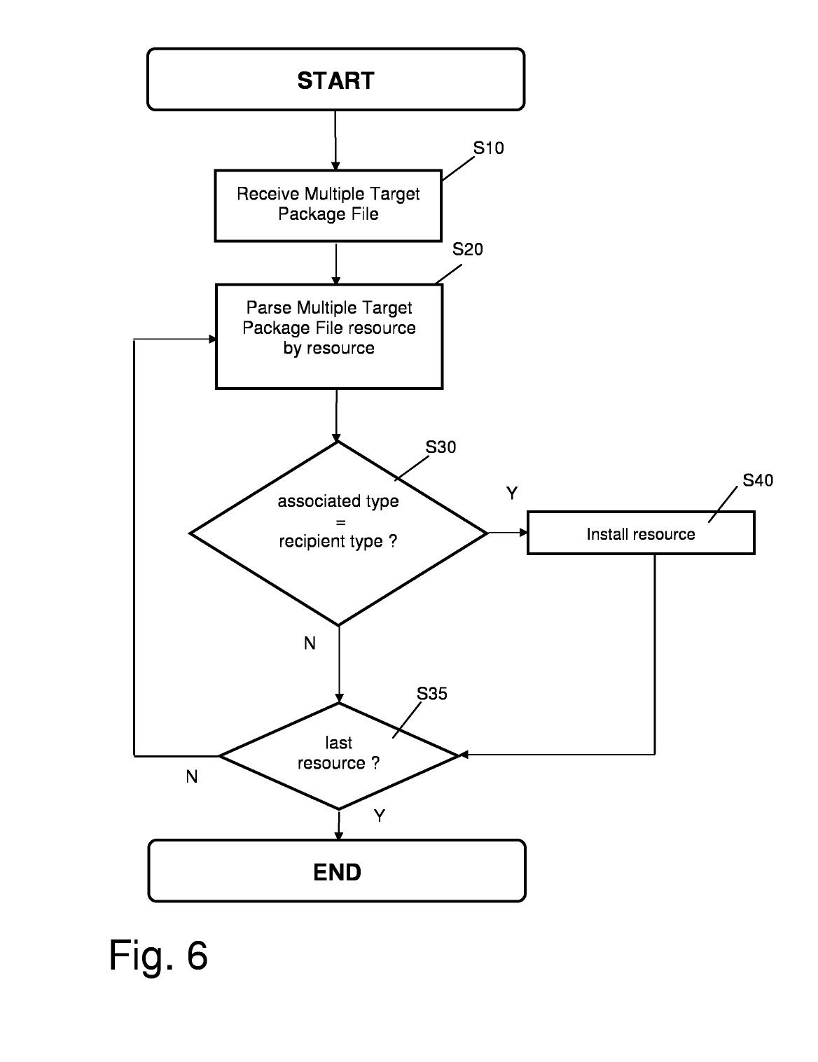

FIG. 6 is a flow chart for illustrating the process of selecting and installing resources from multi-platform printer resource package files that are targeted for the recipient.

After receiving the multi-platform printer resource package file at step S10, the parser of the recipient's device parses the multiple target package file, resource by resource (step S20). For instance, in the example of FIG. 5, the first resource is resource “A” of type “font”, which is associated to platforms TH2 and CG6. Let us, by way of example, assume that the receiving platform is of type CG6. In the next step (S30), the parser compares that the type associated with the resource matches the type of the recipient. In the assumed example (CG 6), the result of the comparison is “yes” (Y), since CG6 is included among the platforms associated with font resource “A”. Consequently, the flow proceeds to step S40, wherein the resource is installed. Subsequently, the parser determines in step S35 where the installed resource is the last resource included in the received package file. If this were the case (S35: Y), the flow would proceed to the end. In the contrary case (S35: N), which may be assumed in the given example, since there are further entries in package file p.pkg of FIG. 5, the processing flow returns to step S20, and the next resource entry is parsed. In the assumed example, this would be entry 40.00.03.00 of type “firmware”. Since said entry is associated only with platform TH2, which does not correspond to the recipient's type, subsequent step S30 determines non-matching (S30: N), and the flow immediately proceeds to step S35.

Thus, the entries of package files are processed resource by resource, until the processing comes to the end, after the last resource entry has been processed (S35: Y). Thereby only a single package file has to be distributed, while nevertheless only the correct versions of the resources, intended for a particular recipient, are installed.

In the following, a further particular aspect of the present invention relating to setup configuration files, which may be included in a multiple platform package file, will be described in more detail. Setup configuration files include particular configuration settings that can be set on a printer, including but not limited to print control settings (such as adjustment settings and image settings), media settings, system settings, regional settings (such as language settings, unit settings, and time zone settings), and network settings such as settings for wireless communication. Some of these settings may have to be changed from time to time in a printing device or computing device for control/emulation. For instance, regional settings may have to be changed if the printer or computer is moved to another region. Conventionally, in the case of distributing configuration files within package files, each time a certain particular setting has to be changed, an updated version of the complete configuration file is provided within the package file for update, and all settings of the recipient have to be set once again, although usually only a few of them are actually changed. The others will simply be overwritten again with the same (i.e. the old) value without any change. Nevertheless, a large amount of data has to be transferred, and a respective extended processing has to be performed at the recipient's side. Including all settings for the printer into each setup configuration file is therefore disadvantageous. For instance, only a few settings such as IP addresses, specific offsets etc. are not identical on every printer, whereas most of the settings are common, if they, for instance, use the same layouts. Therefore, according to an aspect of the present invention, besides a full setup configuration file, also a partial configuration file can be created, wherein the creator can disable arbitrary items. Said aspect may be employed particularly advantageously, if the package file includes an association between resources and individual printers (not only printer types).

According to said aspect of the present invention, for each recipient, there are two configuration files. The files have the same syntax, and every line has one single setting.

The first one of these files (a full setup configuration file) contains every setting in the printer and always exists on the printer. The second one of the files (partial configuration file) contains only those entries that correspond to the changes of configuration that are intended to be made (by the vendor or distributor or by a local server such as AEP server), and only exists until it has been used by the printer.

The printer reads its own full configuration at startup, and stores said full setup configuration file, for backup and restoring purposes. Later, when updates are desired, the partial configuration file is received, and the printer performs only the desired changes to the already existing configuration. After this, the additional (partial) setup configuration file is removed, and the printer retains only a single file again. However, it is still possible to completely change the configuration on the printer, by changing the full setup configuration file (i.e. replacing the permanently stored full setup configuration file with another one).

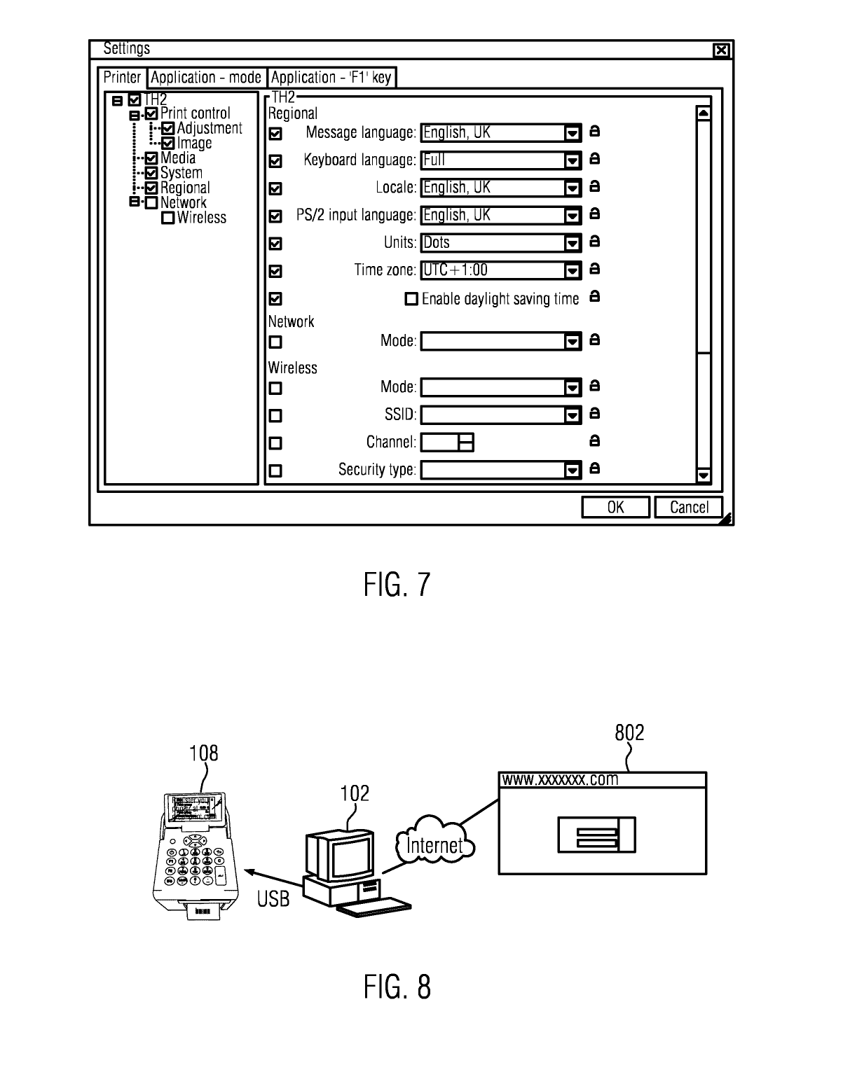

For simplifying the process of deciding which settings are desired to be included for being changed in a partial configuration file, this may be performed in accordance with a specific embodiment of the present invention, by means of a specific graphical user interface. Such a graphical user interface is installed on a data processing device (computer) that is provided at the site of a distributor of package files and in particular, setup configuration files. The Graphical User Interface is part of a configuration tool, such as AEP Works. By way of a particular example, a graphical user interface of the configuration tool AEP Works is illustrated in FIG. 7. By checking the tick boxes on the left hand side, an operator of the configuration tool can decide if the setting shall be included in the partial setup configuration file or not.

As a consequence, the present invention provides a configuration tool that can set every setting in the printer, but it does not have to set every setting. Each item in the setup can be sent to the printer (by being included into the partial configuration file transmitted), or be left out to use the old setting in the printer. If a setting is left out (for instance by including dummy data, or simply omitting the setting), the parser at the recipient's side simply ignores the respective setting, thus leaving the current setting in the printer (or computing device controlling/emulating the printer) unchanged. Hence, there is no need to distribute all the settings from a configuration tool such as AEP Works, to only change a few settings. Moreover, an operator of the configuration tool does not even need to know all of the settings to only change a few of them; to the contrary, he or she can simply omit those settings that are not desired to be changed, when creating the partial configuration file for update.

It is finally noted that the particular aspect of preparing and employing partial configuration files, although it may be included into the general concept of multi-platform printer resource package files, can also be realized independently of said framework. In particular, the concept of full and partial setup configuration files can also be employed in the framework of conventional package files (i.e. package files created and distributed only to a single type of printers or an individual printer, or even if the setup configuration files are distributed in another manner, such as separately, i.e. without being included into package files at all). It is only essential for the aspect that two kinds of setup configuration files are created and used (a full and a partial setup configuration file), which are equal to each other in syntax or at least compatible in a manner that enables a recipient to parse a partial setup configuration file, wherein a part of the entries is missing or contains only dummy data.

In the following, some particular examples of configurations, in the framework of which the present invention can be employed, are illustrated in some more exemplary detail.

A first such configuration is illustrated in FIG. 8. In said example, it is assumed that the customer is a restaurant having a computer 102 connected to the Internet and employing at least one printer 108, for instance, a small portable printer having an interface to be connected with the computer via USB. The vendor of the printer as well as the firmware and/or application software is assumed to be a company, which, for sake of simplicity, will be called the “B company” in the following. Said company is accessible over the internet under a webpage 802 that is assumed to have the fictitious internet address www.xxxxxxxx.com.

Initially, the customer received some “empty” printer. This means that on the printer there is only the “B company” firmware, but no customer application has been loaded so far. Subsequently, the customer (restaurant) registers the printer at the webpage www.xxxxxxxx.com. After having the printer registered, the restaurant downloads their unique application from said website to the PC 102 as a “.pkg” file (package file). Subsequently, the restaurant uses the received package file to update the printer via USB.

To give a specific example, it may be assumed that printer 108 is a label and tag printer belonging to the series “TH2”, from SATO. In that case, the computer of the customer is provided with a specific TH2 downloader tool to update the printer via USB by double clicking on the “.pkg” file. On the other hand, in that case, the “B company” is provided with AEP works software as a configuration tool for creating specific applications for updating the customer's printer.

Thus, the “B company” is designing each printer application centrally based on the requirements of each restaurant, using a configuration tool such as AEP works.

The present invention is capable of simplifying the procedure in the framework of the given example. The “B company” can include the applications designed for different printers into a multiple target package file according to the present invention which is then distributed to all customers. The recipient device on the customer's premises selects and installs the applications which are for that customer. In particular, the multiple target package file may also include optional individual printer information. Said information may also indicate a group of individual printers, such as the printers of a particular customer (restaurant).

All customer transactions will be entered through the “B company's” website. Each restaurant registers their printer (serial number, restaurant data, etc.), downloads their application to PC 102, uses the tools such as TH2 downloader to upgrade the printer with the latest application, performs regular updates if pop-up items are changing, and is moreover capable of ordering labels via the Internet on the homepage of the “B company”.

In accordance with an alternative embodiment, the customers such as restaurants are capable of updating the printer directly from the website without using a tool such as TH2 downloader in between. For this purpose, the printer will have to be provided with an interface for directly accessing the “B company” through the Internet, or via a computer 102, by means of a USB cable interface.

The printer setup file (configuration file) can have some portions of the configuration parameters being the same, such as print speed, print darkness, etc., and some of the parameters partially excluded such as communication parameters that can be different depending on the local system setup in the store, such as LAN/WiFi configurations. This can be achieved by preparing and downloading the respective settings to be changed, within partial configuration files. Generally, the distributed and received package files according to the above example are multiple target package files, wherein either the TH2 downloader or an application running on the printer itself, operate as a parser for determining and selecting only those resources that are designated for the printer itself.

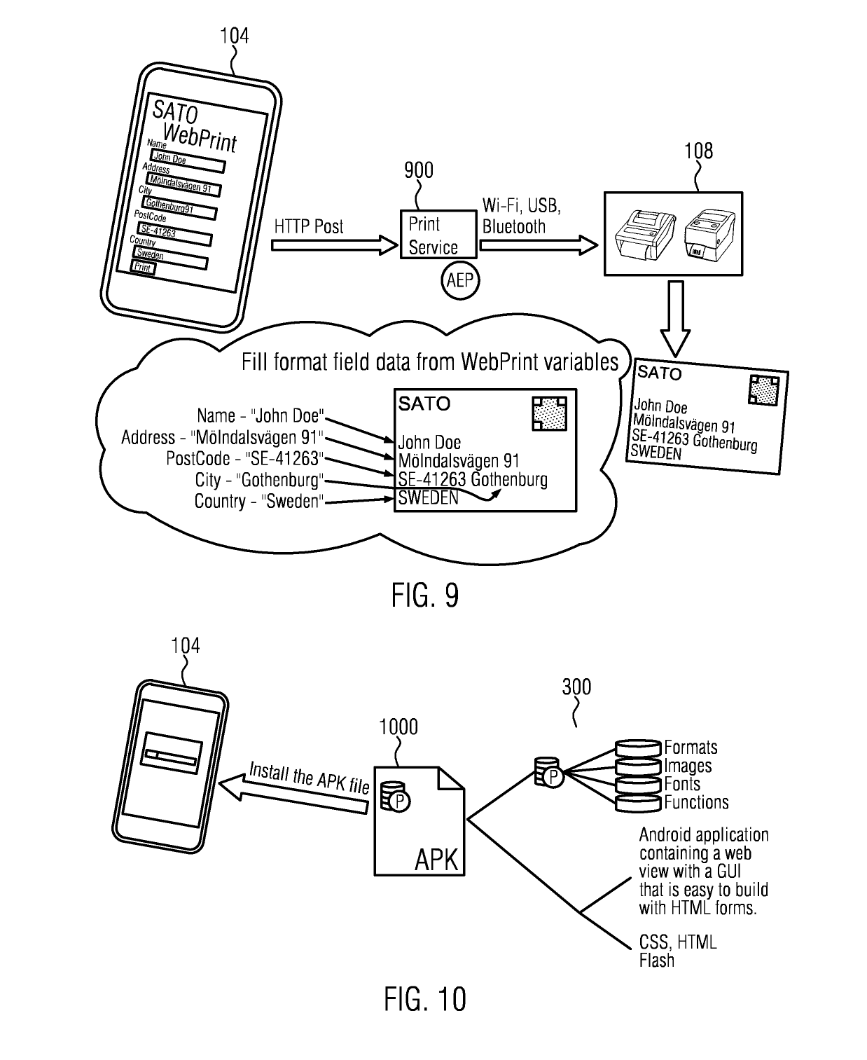

FIG. 9 gives another example illustrating fields of application of the present invention. FIG. 9 shows a computer 104 (in this particular case: a smartphone) and a plurality of printers 108. Smart phone 104 and printers 108 communicate with each other via a Print Service 900. Print Service 900 is an application to provide an alternative user interface to the Psim (printer emulation) that is normally used in computer 104. With this Print Service, inputs can be provided via a HTTP Post mechanism (a mechanism developed for the world wide web transfer of data, usually used for submitting forms), instead of the user entering it on the emulated keyboard of the Psim application. Hence, it can be said that the Print Service emulates an AEP (stand alone) printer, but not the printer's user interface.

Physically, Print Service 900 may be included in computer 104. Alternatively, it may run on a separate computing entity. In that case, illustrated in FIG. 9, communication is preferably accomplished via wireless communication such as WiFi, or Bluetooth. Alternatively, a wired connection, such as a USB connection can also be used.

Smartphone 104 has an application called SATO AEP WebPrint installed thereon. Said application enables the customer to create applications by using HTML Forms to control a printer 108 to print formats with variable data. This enables the customer to create graphical user interfaces in a flexible way by using, for example, HTML, CSS (Cascading Style Sheets), Adobe Flash or Java, as long as the data is sent using HTTP post variables to the Print Service 900, which will handle all printer communication and formats. In particular, this is done by filling in format field data from WebPrint variables. A user inserts the desired data by filling in a format field screen of the WebPrint variable screens shown on the smart phone 104. The data filled into the form is then processed by the AEP printer emulator within Print Service 900, resulting in a printout on the non-AEP printer. The result of printing by associated printer, in this case a business card, is shown in the right lower portion of FIG. 9.

Hence, it can be said that AEP WebPrint is an application that “fills in a form” provided by Print Service 900. The resulting data are posted to Print Service 900, i.e. an AEP printer emulator with no user interface, for enabling printer 108 to print out.

In the following, the steps for developing an application, such as WebPrint illustrated in FIG. 9, will be explained step by step.

In a first step, a package file is created. Said package file, to be created within a configuration tool such as AEP Works contains formats, images, fonts and functions. To connect the field to a graphical user interface, in this specific case, to a WebPrint GUI, it is necessary to set a fix field value by using the add sign to name the variable (for example: ‘@FirstName’ to be set by using an HTML form input with the name attribute set to “FirstName”). Fonts, images, functions and printer setup used by the formats will be embedded in the package. Special script methods such as input, display and table methods cannot be used together with WebPrint. The WebPrint application/Android application will handle the data sources.

In a second step, a web form is created with input fields with the variable names that were created in the format. To choose from printable formats, an HTTP Post variable named “Format” is used.

In a third step, an application (in the present example: an Android application (APK file ‘.apk’)) that contains the package and web form files is built.

The application should install the package file to the Print Service 900 and display the web form and send the HTTP Post request to the service. Everything can be included in one .apk including the Print Service or the WebPrint application and Print Service can be deployed separately.

After the application has been developed, in the next step, the application has to be deployed on computer 104, in the present example—an Android smartphone. As can be seen on the right hand side of FIG. 10, APK files include a package file 300 having formats, images, fonts and functions, and an Android application containing web form files, i.e. a web view with a graphical user interface that can be easily built with HTML forms. To deploy an application on Android device 104, the APK file1000 has to be run, and the application will automatically be installed and ready to run.

The present invention enables to simplify the deployment by using multiple target package files as the package files within the APK files.

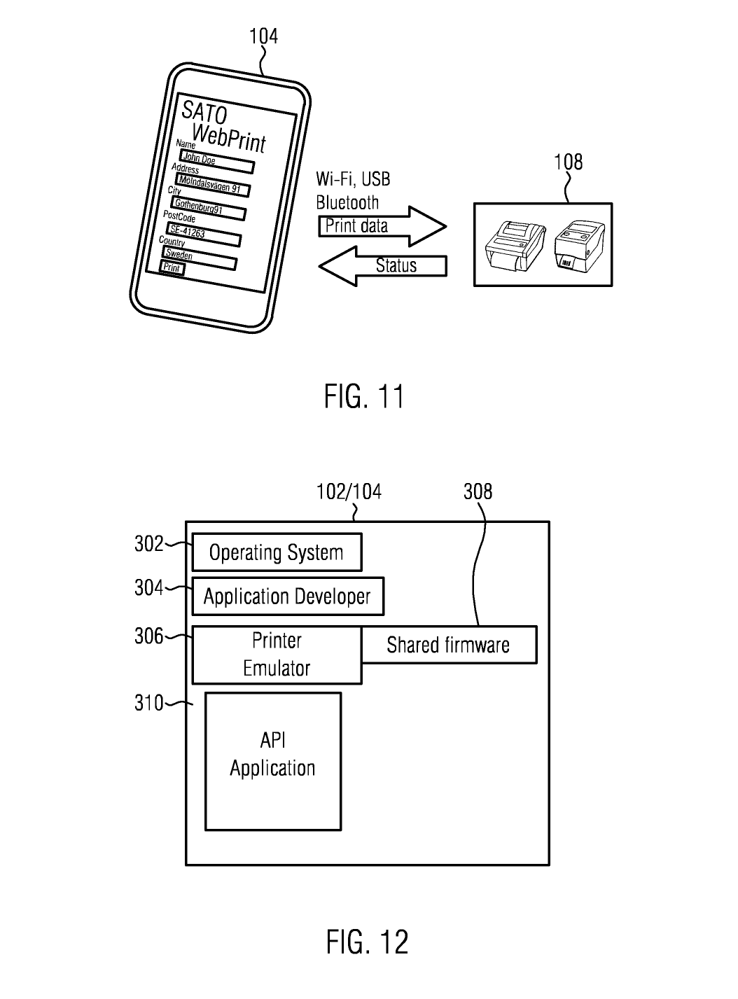

FIG. 11 illustrates an example of operation after the WebPrint application has been successfully installed on the smartphone 104. As can be seen from FIG. 11, the communication channel between smartphone 104 and printer 108 is used in a bi-directional manner. In the first direction, from smartphone 104 to printer 108, print data are transmitted. During operation, the operator is following directions in the web application. The operator can change setup parameters in print service if they have not been locked by the developer (optional). Thereby, the print data that are subsequently sent to the printers 108 are prepared.

The opposite direction of communication, from printers 108 to smartphone 104 is used for the purposes of status monitoring. The print service takes care of monitoring data communication and errors that occur on the printer side and notifies the operator.

As mentioned above, a bi-directional communication channel can be set up via USB, Bluetooth, WLAN or LAN. A person skilled in the art is aware that any other suitable communication protocol can be used as well without being limited to those listed above by way of example.

FIG. 12 is a block diagram that illustrates software components that are provided with a computer such as a server 102 or a workstation 104, which is adapted for emulating a printer, as well as for developing printer applications. In FIG. 12, the computer includes an operating system 302 (for instance, Microsoft Windows). Further, the computer includes application developer 304, printer emulator 306, shared firmware 308 and API application 310.

Application developer 304 includes, for example, an integrated development environment for developing new or modifying existing printer applications, such as that developed in the Lua programming language and that are deployable to one or more printers 108 for printing formatted output, such as labels. Virtual printer emulator 306 is operable to provide a virtual representation of a printer 108 that executes the printer application developed, for example, via application developer 304. As noted above, the firmware of the printer 108 is preferably provided with the computer that enables the emulator 306 to accurately represent printed output and the way that the printer 108 will function while the application is executing.

In the following, three further examples are given, wherein one package file contains different resources for two different printer models. In accordance with the present invention, only a resource that is intended for a specific printer is installed in that printer. The other resources are installed in the other printer. The following conditions are common for said examples. Firstly, one package file contains different label formats and setup data, but the same Lua application and data table. The label is printed out using calculations by use of Lua functions which are included in the package file as one of the items (resources). Secondly, the label format, product data and Lua application are the same, but the label is printed on different printer models with different setup configuration due to physical differences of the printers.

As previously indicated, if no real/physical printer is available, the functionality of the application and the appearance of the labels can be confirmed by using a tablet or using a printer emulator such as AEP Psim on a personal computer.

The first example relates to the case of the sorting of food at a fruit plantation factory where labels are printed out by an industrial printer connected to a scale. A label could include the weight, number of pieces, and grade/rating of fruit. Then, in the supermarket, when the customer selects and bags some apples from the same grade, the information such as grades and rating, the total amount of weight, price per kilogram (kg) and the overall price would be printed on the label by a label and tag printer such as SATO TH2, which is also connected to a scale. In the common package for the industrial printer and the label and tag printer, product data and Lua functions could be the same for the two printers but the label formats and printer setup data could be different due to different physical characteristics of the two printers such as print width, print speeds, print resolution, etc. When downloading the same package file to the two printer models, they would only install what is tagged to their platform.

As a result, labels can be printed out by automatically calculating the weight and price by use of a Lua application and an external scale device which is connected to the printer.

The second example regards a label which is used on a shelf in the supermarket (shelf label). It is an example which requires the same label format but different types of printers.

Sometimes, the labels fall from the shelf or a new label is printed in accordance with the changing of products, product data or price. A supermarket may have two types of printers for printing the shelf labels, one being a stationary label printer which is located in the back-office and another being a mobile printer which clerks/shop assistants wear in the store.

Then, the same format could be printed out on both printer models by use of a smart phone with AEP firmware thereon, because it has a scanner function, format data and product code data etc. All parameters are partially excluded and no configuration data will be transferred to the printer. The printer configuration will have to be set locally on the printer using printer keyboard/display or other means.

The third example is similar to the second example and relates to physical distribution/logistics where a shipping label has to be printed and attached to the goods. If something is small enough to be put on a conveyor belt or on carts, the label may be printed by an industrial printer that is in a fixed position next to the conveyor belt. However, when an address label shall be affixed to a larger item that cannot be transported on the conveyor belt or on carts, workers will have to go to the place where the large-sized goods are stored and print a label with a mobile printer. The same format, product data, Lua function etc. can be shared between the different printer models, but two different setup files can be applied. The setup files can contain all setup parameters or have parts of them being disabled (partial configuration files) and those that are disabled will be ignored and will not effect the printer setup.

As indicated above, the latter idea of having partial configuration files can also be employed independently for the multi-platform printing resource target package files.

Hence, in accordance with a particular aspect of the present invention, a data processing device is provided, comprising a setup configuration tool for creating a setup configuration file including printer setup configuration. The setup configuration tool is adapted to create, for a particular type of printer, a full setup configuration file and a partial setup configuration file. The full setup configuration file includes every setting in the printer. The partial configuration file includes only a part of the settings in the printer that are desired to be changed.

According to a further particular aspect of the present invention, a data processing device for controlling or emulating a printing operation of a particular printer is provided. Said data processing device comprises a receiving section for receiving a setup configuration file. Further, the data processing device comprises a setup configuration section that is adapted to parse a partial setup configuration file that has been received by the receiving section, wherein the partial configuration file includes only a part of the settings of the particular printer that are desired to be changed. The setup configuration section, upon parsing a partial configuration file, changes only the desired settings included in the partial configuration file and leaves the settings of the particular printer that are not included in the partial configuration file unchanged.

Preferably, the partial setup configuration file has the same syntax as a full setup configuration file that includes every setting of the particular printer.

Within the framework of the two particular aspects of the present invention summarized above, the further details of embodiments herein described within the framework of data processing devices for handling target package files are applicable as well.

Moreover, particular features of embodiments described so far can be combined, as long as such a combination does not lead to any contradiction in itself or to a contradiction to the appended claims.

In summary, the present invention relates to a printer being capable of parsing, understanding and evaluating multiple target package files that include printing resources not only for a single printer or for a single type of printer, but for multiple printers or multiple types of printers. For this purpose, the package file is augmented with platform information that is separately associated with each printer resource included in the package file. Thereby, the parser of the printer can discriminate whether or not a particular resource is applicable to itself. Consequently, only the resources such as firmware are installed that are valid and applicable to the printer. In the same manner, the resources can also be augmented with individual printer information, so as to indicate different resources to be installed on different printers, even if they are of the same type.

1.-44. (canceled)

45. A package file comprising:
a plurality of resources for a plurality of different printers and platform information indicating a type of printer, wherein the plurality of resources include data necessary for performing printing operations on said different printers; and each of said resources in the package file being associated with platform information indicating printer types corresponding to the resource.

46. The package file according to claim 45, wherein the platform information associated with a resource is stored as an attribute of said resource.

47. The package file according to claim 45, wherein at least a part of said resources in the package file being further associated with individual printer information indicating at least one individual printer out of printers of the types of printers indicated by the platform information associated with the resource.

48. The package file according to claim 47, wherein each of said resources in the package file being further associated with type information indicating a type of said resource.

49. The package file according to claim 47, wherein said type of said resource being one of firmware, font, Lua script, layout, WLAN firmware, or setup configuration file.

50. The package file according to claim 47, wherein the type information and/or the individual printer information associated with a resource are stored as attributes of said resource.

51. The package file according to claim 45, wherein the plurality of resources includes at least one of firmware, fonts, Lua scripts, sub-board firmware for LAN or WLAN, and layout data.

52. The package file according to claim 45, wherein the plurality of resources includes a setup configuration file.

53. A computer readable recording medium having recorded thereon a package file according to claim 45.

54. A data processing device for controlling or emulating a printing operation of a particular printer, said data processing device comprising:
a receiving section for receiving a package file according to claim 45,
a package parsing section for parsing each resource included in said package file and comparing the platform information associated with each resource with the type of said particular printer, thereby determining those resources out of the plurality of resources included in the package file the associated platform information of which indicates a printer type matching the type of the particular printer, as resources matching the type of the particular printer, and
an installing section for installing on said data processing device the resources determined by said package parsing section as matching the type of the particular printer.

55. The data processing device according to claim 54,
wherein, in said package file, at least a part of said resources in the package file being further associated with individual printer information indicating at least one individual printer out of printers of the types of printers indicated by the platform information associated with the resource,
said package parsing section further comparing the individual printer information with individual printer information of the particular printer, thereby determining those resources out of the resources associated with individual printer information, which have associated therewith an individual printer information matching the individual printer information of the particular printer, and
said installing section installing on said data processing device, out of the resources associated with individual printer information and matching the type of the particular printer, only the resources, which have associated therewith an individual printer information matching the individual printer information of the particular printer.

56. The data processing device according to claim 55, wherein said particular printer is a label and tag printer.

57. A printer including a data processing device according to claim 55 for controlling a printer operation of said printer.

58. The printer according to claim 57, wherein the printer is a label and tag printer.

59. A method of configuring a data processing device for controlling or emulating a printing operation of a particular printer, comprising the steps of
receiving, at the data processing device, a package file according to claim 45,
parsing each resource included in said package file and comparing the platform information associated with each resource with the type of said particular printer, thereby determining those resources out of the plurality of resources included in the package file the associated platform information of which indicates a printer type matching the type of the particular printer, as resources matching the type of the particular printer, and
installing on said data processing device the resources determined as matching the type of the particular printer.
